(19) United States
(12) Patent Application Publication
(10) Pub. No.: US 2003/0226270 A1
(43) Pub. Date: Dec. 11, 2003

(54) Level for indicating object tilt along user line of sight

(76) Inventor: Harold A. Leasure, Pembroke Pines, FL (US)

Correspondence Address: FRANK L. KUBLER, 13261 S.W. 54th Court, Miramar, FL, 33027, US

(21) Appl. No.: 10/163,115

(22) Filed: Jun. 5, 2002

(51) Int. Cl. G01C 9/00

(52) U.S. Cl. 33/370

(57) ABSTRACT

A level apparatus for indicating the orientation relative to vertical of a surface of an object extending along a user line of sight, including a fluid vessel containing an indicator fluid including a liquid and having a fluid surface, the fluid vessel having a vessel abutment region with a rearward abutment wall for placing against a surface of an object to be evaluated for tilt and with a forward display wall including a fluid display window extending generally perpendicular to the user line of sight, the fluid surface being visible in the fluid display window when the abutment wall is substantially upright, and includes a vessel reservoir region extending at least one of: rearwardly and forwardly from the vessel abutment region along the user line of sight, the vessel abutment region and the vessel reservoir region being in mutual fluid communication.

### BACKGROUND OF THE INVENTION

1. Field of the Invention

The present invention relates generally to the field of levels which indicate the orientation of a surface relative to horizontal or vertical. More specifically the present invention relates to a level apparatus for indicating the tilt of an object surface toward or away from a user, or in other words along the user line of sight rather than across the user line of sight, such as for continuously indicating to a driver seated in a load-carrying fork lift truck the forward or rearward tilt of the truck to prevent hazardous forward or rearward instability, and for indicating to a construction worker whether an upright building element is truly vertical or is tilted toward or away from the worker. The level apparatus includes a fluid vessel containing an indicator fluid in the form of a liquid which preferably is pigmented for easy visibility, the fluid vessel having a vessel abutment region with a rearward abutment wall for placing flat against a surface to be evaluated for tilt and with a forward display wall including a fluid display window extending perpendicular to the user line of sight with a fluid level indicating mark, the fluid surface being visible in the fluid display window when the abutment wall is upright and the apparatus is thus oriented for use, and includes a vessel reservoir region extending either rearwardly or forwardly from the vessel abutment region along the user line of sight, the vessel abutment region and vessel reservoir region being in mutual fluid communication so that fluid in the vessel reservoir region either flows into or out of the vessel abutment region depending on the tilt of the level along the user line of sight. The vessel reservoir region contains a sufficient quantity of fluid that forward or rearward tilting of the rearward abutment wall a number of degrees considered significant for the intended use creates a readily apparent change in the position of the fluid surface in the fluid display window relative to the fluid level indicating mark to make the tilt of the apparatus and object surface noticeable to the user.

2. Description of the Prior Art

There have long been levels for determining whether an upright surface of an object tilts to the left or to the right across the user line of sight. A problem with these prior levels has been that they do not indicate the tilt of an upright surface toward or away from the user, along the user line of sight. The user is forced to circle around an object, such as a post or column, to take a series of level readings, or two users must take simultaneous level readings, along perpendicular directions. What is needed is a level apparatus which indicates tilt toward or away from a user, and which can be structurally combined with or used in combination with a conventional level, to indicate the tilt of an upright member along and across the line of sight at the same time.

It is thus an object of the present invention to provide a level apparatus which indicates to a user the orientation of an upright object relative to vertical along the line of sight of the user.

It is another object of the present invention to provide such a level apparatus which can be structurally combined with or used in combination with a conventional level to simultaneously indicate the tilt of an upright object both along and across the user line of sight.

It is still another object of the present invention to provide such a level apparatus which is operable in a fully inverted position to be reversible and fit around a left hand corner or around a right hand corner of an upright object and give the user the level reading.

It is finally an object of the present invention to provide such a level apparatus which is simple in design, compact, light in weight, sturdy and inexpensive to manufacture.

### SUMMARY OF THE INVENTION

The present invention accomplishes the above-stated objectives, as well as others, as may be determined by a fair reading and interpretation of the entire specification.

A level apparatus is provided for indicating the orientation relative to vertical of a surface of an object extending along a user line of sight, including a fluid vessel containing an indicator fluid including a liquid and having a fluid surface, the fluid vessel having a vessel abutment region with a rearward abutment wall for placing against a surface of an object to be evaluated for tilt and with a forward display wall including a fluid display window extending generally perpendicular to the user line of sight, the fluid surface being visible in the fluid display window when the abutment wall is substantially upright, and includes a vessel reservoir region extending at least one of: rearwardly and forwardly from the vessel abutment region along the user line of sight, the vessel abutment region and the vessel reservoir region being in mutual fluid communication so that the fluid in the vessel reservoir region flows into and out of the vessel abutment region depending on the tilt of the apparatus along the user line of sight and thereby alter the elevation of the fluid surface in the fluid display window; where the reservoir region contains a sufficient quantity of the fluid that substantial tilting of the abutment in one of a forward direction and a rearward direction creates a readily apparent change in the position of the fluid surface visible in the fluid display window to make the tilt of the apparatus and of the surface of the object noticeable to the user.

The fluid preferably is pigmented for easy visibility. The vessel abutment region and the vessel reservoir region are upright boxes which are joined in full fluid communication at box ends to form a vessel which is substantially L-shaped along a horizontal cross-section. The fluid display window optionally is a panel inset into a port in the display wall.

The level apparatus preferably additionally includes a fluid indicating mark on the display window for comparison with the position of the fluid surface. The level apparatus optionally includes several of the fluid level indicating marks to indicate the extent of apparatus and object surface tilt. The vessel abutment region and the vessel reservoir region optionally are each shaped substantially as hollow half circular cylinders.

The vessel alternatively is configured as a length of tube joined at its ends to form a continuous and substantially rectangular tube loop, the tube loop including upper and lower generally horizontal tube segments and first and second generally vertical tube segments, the tube being bent at opposing vessel region dividing points along the upper and lower horizontal tube segments to define on one side of the vessel abutment region and on the other side the vessel reservoir region, the tube containing the fluid.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective front view of the first preferred embodiment having an opaque housing with a transparent display window, the abutment and reservoir regions having the optional semi-cylindrical shape.

FIG. 2 is a perspective side view of the embodiment of FIG. 1 fitted against a surface of an upright object such as a column, the housing being transparent and revealing the indicator fluid with a fluid surface indicating an object surface tilt toward the display window/apparatus user.

FIG. 3 is a front view of a variation of the first embodiment, having the optional, conventional bubble tube sight glass level integrated into the forward display wall of the abutment region, to give level readings across the user line of sight as the reservoir region abuts the object.

FIG. 4 is a perspective view of the second embodiment having the tube loop, the tube loop having a transparent tube wall revealing the indicator fluid.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various Figures are designated by the same reference numerals.

First Preferred Embodiment

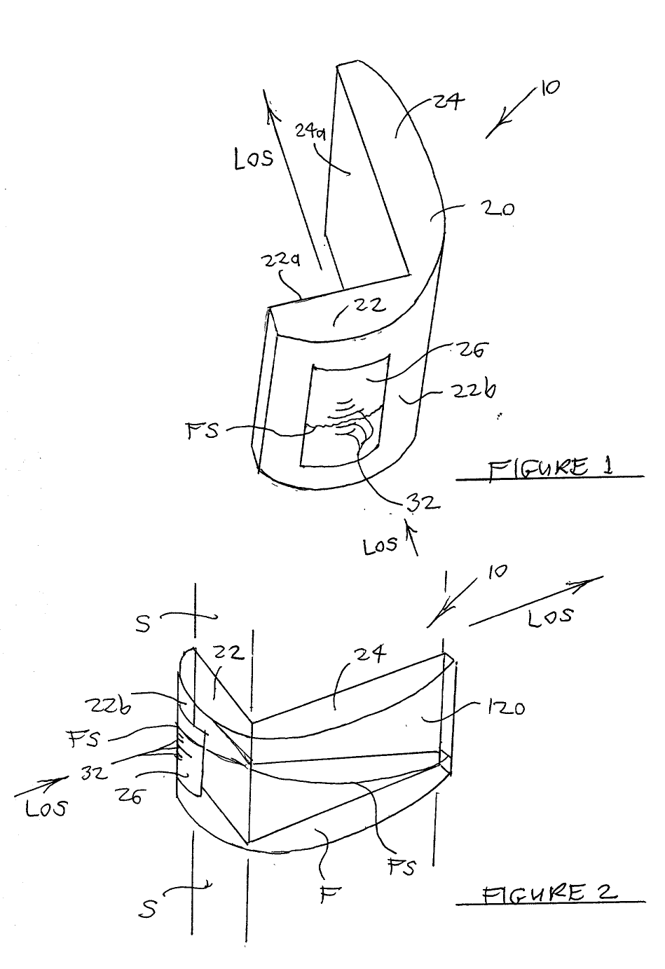

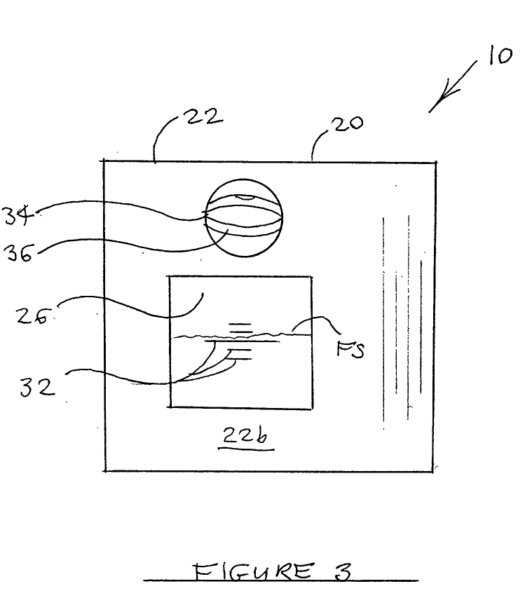

Referring to FIGS. 1-3, a level apparatus 10 is disclosed for indicating the orientation relative to vertical of a surface of an object toward or away from a user. Level apparatus 10 includes a fluid vessel 20 containing an indicator fluid F in the form of a liquid which preferably is pigmented for easy visibility, the fluid vessel 20 having a vessel abutment region 22 with a rearward abutment wall 22a for placing flat against a surface S to be evaluated for tilt and with a forward display wall 22b including a fluid display window 26 extending perpendicular to the user line of sight LOS with a fluid level indicating mark 32, the fluid surface FS being visible in the fluid display window 26 when the abutment wall 22a is generally upright and includes a vessel reservoir region 24 extending either rearwardly or forwardly from the vessel abutment region 22 along the user line of sight LOS, the vessel abutment region 22 and vessel reservoir region 24 being in mutual fluid communication so that fluid F in the vessel reservoir region 24 either flows into or out of the vessel abutment region 22 depending on the tilt of the level along the user line of sight LOS. The vessel reservoir region 24 must contain a sufficient quantity of fluid F that forward or rearward tilting of the rearward abutment wall 22a a number of degrees considered significant for the intended use creates a readily apparent change in the position of the fluid surface FS in the fluid display window 26 relative to the fluid level indicating mark 32 to make the tilt of the apparatus 10 and object surface S noticeable to the user.

For one embodiment the vessel abutment region 22 and vessel reservoir region 24 are upright boxes which are joined in full fluid communication at box ends to form substantially an L-shape along a horizontal cross-section. Fluid display window 26 can be an inset transparent or translucent panel in the forward display wall 22b or the entire vessel 20 can be translucent or transparent. Either a single indicating mark 32 in the form of a horizontal indicating line or a vertical series of horizontal indicating lines 32 is preferably provided for comparison to the position of the adjacent fluid surface FS to indicate tilt and, where present, the degree of tilt. The vessel abutment and reservoir regions 22 and 24 each may be shaped substantially as hollow half cylinders.

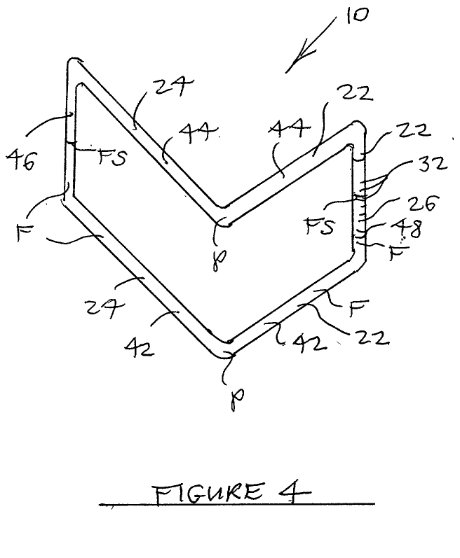

A conventional sight glass level 34 optionally is inserted into a sight glass level port 36 in the forward display wall 22b so that apparatus 10 simultaneously indicates the tilt of an upright object relative to vertical both along and across the user line of sight. The sight glass level 34 takes its reading from apparatus 10 orientation resulting from abutment of vessel reservoir region abutment wall 24a with an upright side of the object which is perpendicular to the side of the object which the rearward abutment wall 22a abuts from which fluid display window 26 takes its reading. See FIG. 3. In other words the addition of the sight glass level 40 to apparatus 10 permits the user to determine whether an object leans toward or away from the user, and simultaneously to determine whether the object leans to one side or the other as viewed by the user.

Second Preferred Embodiment

For another embodiment fluid vessel 20 is a length of tube 40 joined at its ends to form a generally rectangular loop including upper and lower horizontal tube segments 42 and 44, respectively, and first and second vertical tube segments 46 and 48, the tube 40 being bent at opposing bend points P along upper and lower horizontal tube segments 42 and 44 to divide vessel 20 and define on one side of the bend vessel abutment region 22 and on the other side vessel reservoir region 24, the tube 40 containing the indicator fluid F. See FIG. 4. Vessel abutment region 22 includes first vertical tube segment 46 which in part or in whole is either translucent or transparent to function as the fluid display window 26 and preferably has at least one fluid level indicating mark 32. The vessel reservoir region 24 includes second vertical tube segment 48 which receives added fluid F when fluid F flows out of vessel abutment region 22 during backward apparatus 10 and object surface S tilting and releases subtracted fluid F during forward apparatus 10 and object surface S tilting. A tube 40 in the configuration of a continuous loop rather than a broken loop divided by closed ends or a barrier is preferred because air or other gas above the fluid F moves around loop 40 together with the fluid F so that no portion of the gas can become compressed during fluid F flow and thereby cause fluid flow resistance.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A level apparatus for indicating the orientation relative to vertical of a surface of an object extending along a user line of sight, comprising:
a fluid vessel containing an indicator fluid including a liquid and having a fluid surface, said fluid vessel having a vessel abutment region with a rearward abutment wall for placing against a surface of an object to be evaluated for tilt and with a forward display wall including a fluid display window extending generally perpendicular to the user line of sight, the fluid surface being visible in the fluid display window when said abutment wall is substantially upright, and includes a vessel reservoir region extending at least one of: rearwardly and forwardly from the vessel abutment region along the user line of sight, said vessel abutment region and said vessel reservoir region being in mutual fluid communication such that said fluid in said vessel reservoir region flows into and out of said vessel abutment region depending on the tilt of said apparatus along the user line of sight and thereby alter the elevation of the fluid surface in said fluid display window;
wherein said reservoir region contains a sufficient quantity of said fluid that substantial tilting of said abutment in one of a forward direction and a rearward direction creates a readily apparent change in the position of the fluid surface visible in said fluid display window to make the tilt of said apparatus and of the surface of the object noticeable to the user.

2. The level apparatus of claim 1, wherein said fluid is pigmented for easy visibility.

3. The level apparatus of claim 1, wherein said vessel abutment region and said vessel reservoir region are upright boxes which are joined in full fluid communication at box ends to form a vessel which is substantially L-shaped along a horizontal cross-section.

4. The level apparatus of claim 1, wherein said fluid display window is a panel inset into a port in said display wall.

5. The level apparatus of claim 1, additionally comprising a fluid indicating mark on said display window for comparison with the position of the fluid surface.

6. The level apparatus of claim 5, comprising a plurality of said fluid level indicating marks to indicate the extent of apparatus and object surface tilt.

7. The level apparatus of claim 1, wherein said vessel abutment region and said vessel reservoir region are each shaped substantially as hollow half circular cylinders.

8. The level apparatus of claim 1, wherein said vessel is configured as a length of tube joined at its ends to form a continuous and substantially rectangular tube loop, said tube loop comprising upper and lower generally horizontal tube segments and first and second generally vertical tube segments, said tube being bent at opposing vessel region dividing points along said upper and lower horizontal tube segments to define on one side of said vessel abutment region and on the other side said vessel reservoir region, said tube containing said fluid.
